(19) United States
(12) Patent Application Publication
(10) Pub. No.: US 2008/0204576 A1
(43) Pub. Date: Aug. 28, 2008

(54) IMAGE RECOVERY DEVICE

(76) Inventors: Tsutomu Kyojima, Kanagawa (JP); Hiroko Ohtake, Kanagawa (JP); Sumito Yoshikawa, Kanagawa (JP); Takanori Miki, Kanagawa (JP)

Correspondence Address: Frank Pincelli, Patent Legal Staff,;Eastman Kodak Company, 343 State Street, Rochester, NY, 14650-2201, US

(21) Appl. No.: 11/765,595

(22) Filed: Jun. 20, 2007

(30) Foreign Application Priority Data
Feb. 23, 2007 (JP) 2007-43195

(51) Int. Cl. H04N 5/335

(52) U.S. Cl. 348/231.99; 348/E05.091

(57) ABSTRACT

A date-stamped captured image is subjected to camera shake correction. When adding date data to a captured image, an image processing IC of a digital camera stores in a storage section image data pertaining to an area where date data are to be added. When a date-stamped captured image is subjected to hand shake correction, the image data stored in the storage section are written over the captured image, thereby causing the date to disappear and perform camera shake correction. After camera shake correction, the date data are again added.

### CROSS REFERENCE TO RELATED APPLICATIONS

This application claims priority to Japanese Patent Application No. 2007-43195 filed on Feb. 23, 2007, which is incorporated herein by reference in its entirety.

### FIELD OF THE INVENTION

The present invention relates to an image recovery device, and more particularly to a device for recovering an original image from an image having added character data such as a date or the like.

### BACKGROUND OF THE INVENTION

A digital camera has recently been equipped with a camera shake correction mechanism for lessening camera shake arising during photographing operation. The camera shake correction mechanism adopts an electronic camera shake correction technique for reading a photographable area during photographing. This occurs by making the area a given size, comparing a first-captured image with subsequently-captured images, computing the amount of offset and automatically shifting a photographable area of the photograph, and recording a photographed image. Also, an optical camera shake correction technique for shifting a correction lens that has a vibrating gyroscopic mechanism is incorporated into a lens in a direction to cancel camera shake, thereby correcting an optical axis. Further, an image-sensor-shift camera shake correction technique can be used to detect camera shake by means of a vibrating gyroscopic mechanism and shifting an image sensor, such as a CCD, CMOS or the like, in response to camera shake, and correct an optical axis. Furthermore, other similar techniques are available. Moreover, a technique for processing a captured image to recover an original image, thereby correcting camera shake, has also been put forward. One known technique is for processing a captured image using a PSF (Point-Spread Function) expressing the amount of camera shake.

Meanwhile, adding date data to an image captured through photographing has been practiced. When an original image is recovered by means of processing the captured image, the manner of processing date data poses a challenge.

Specifically, the captured image is deteriorated by means of camera shake, but no camera shake has arisen in date data themselves. If the entire captured image having added date data is taken as an object of recovery processing, blurring induced by recovery processing arises in the date data. FIG. 5 shows example blurring resulting from date data “30” having been subjected to recovery processing employing a PSF.

JP2002-125184 A describes an electronic camera, wherein an original image, such as a captured image or the like, is processed. An image file which enables regeneration of two types of images, namely, an unprocessed image and a processed image, is created and stored.

Moreover, JP2005-333186 A describes a digital camera which extracts partial image data belonging to a date area in main image data. This camera writes character data showing a date into a date area of main image data and merges partial image data into the date area of the main image data when an operation for deleting a date is performed, thereby deleting the date from a regenerated image.

However, the related-art techniques do not describe recovery of an original image by subjecting a captured image including added date data to camera shake correction or the like. A conceivable method is to store an image not having added date data and a date-stamped image as captured images and to recover, as an object of processing, an image not having added date data when camera shake correction is performed. However, this method induces an increase in the volume of image data to be recorded.

### SUMMARY OF THE INVENTION

The present invention is to provide a device capable of preventing influence to character data even when a photographed image having added character data, such as date data or the like, is subjected as an object to image recovery processing such as camera shake correction or the like.

The present invention provides an image recovery device for recovering an original image from an acquired image;

a unit for creating a character-added image by addition of character data to an acquired image;

a unit for previously storing image data pertaining to an area in the acquired image where the character data are to be added before addition of the character data to the acquired image;

a unit for merging the image data into a character data addition area in the character-added image at the time of recovery of an original image from the character-added image, thereby causing the character data to disappear and recovering the original image; and

a unit for again adding the character data to the recovered original image.

According to the present invention, when an original image is recovered from a captured image having added character data, influence to the character data can be eliminated.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following figures, wherein:

FIG. 1 is an overall block diagram of a digital camera;

FIGS. 2A to 2E are descriptive views of camera shake correction processing;

FIG. 3 is a processing flowchart (part 1) of an embodiment;

FIG. 4 is a processing flowchart (part 2) of the embodiment; and

FIG. 5 is a descriptive view of date data having undergone camera shake correction.

### DETAILED DESCRIPTION OF THE INVENTION

An embodiment of the present invention will be described hereunder.

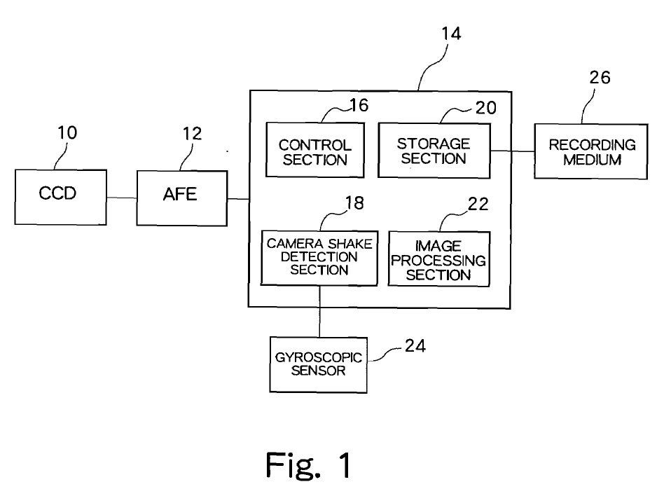

FIG. 1 shows an overall block diagram of a digital camera of the present embodiment. The digital camera of the embodiment has a camera shake correction mechanism for recovering an original image from a captured image after photographing operation, and recovers an original image; i.e., a camera-shake-free image, by use of a PSF.

In FIG. 1, a CCD 10 converts light originating from a subject into an electric signal, and outputs the signal as an analogue image signal. An analogue front end (AFE) 12 subjects the analogue image signal to correlated double sampling, thereby converting the analogue image signal into a digital image signal. The digital image signal is supplied to an image processing IC 14 having as functional blocks a control section 16, a camera shake detection section 18, a storage section 20, and an image processing section 22.

The image processing section 22 of the image processing IC 14 subjects the digital image signal to YC separation, edge enhancement processing, white balance adjustment, color correction processing, γ correction processing, and the like. When a user has selected, from a menu, an addition of date data to a captured image, date data are added to a predetermined position in a captured image, for example, to a lower right position in a captured image. The captured image data having added date data are JPEG-compressed and stored in the storage section 20, and the data are stored further in an external recording medium 26 such as flash memory or the like. The captured image recorded in the external recording medium 26 is decoded and displayed on an rear LCD, or the like, of the digital camera. When adding date data to the captured image, the image processing section 22 extracts image data from an area in the captured image where date data is to be added and stores the extracted image data in the storage section 20.

The camera shake detection section 18 detects the amount of camera shake according to the acceleration detected by a gyroscopic sensor 24, and computes from the amount of camera shake a PSF used for image recovery. The PSF is computed from the amount of movement of an image due to camera shake that is derived from the angular velocity detected by the gyroscopic sensor 24 and an image-scaling factor of an image capturing system. The computed PSF is supplied to the image processing section 22, and the image processing section subjects the captured image designated by the user to camera shake correction using the PSF. A steepest descent method has already been known as example camera shake correction using a PSF. A brief description of the method is as follows. Specifically, ∇J of a captured image is computed. Provided that J denotes the amount of evaluation of a common inverted filter, G denotes a deteriorated image corresponding to a captured image, F denotes a recovered image, and H denotes a deterioration function, we have

J=∥G−HF∥².

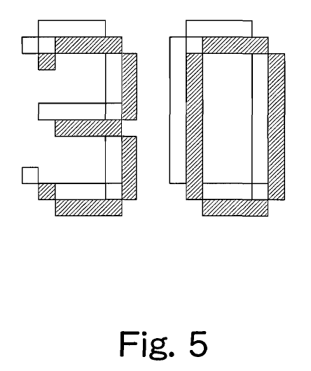

This expression signifies that the amount of evaluation J is determined as the magnitude of a difference between an image HF obtained by subjecting the recovered image F to the deterioration function H and an actual deteriorated image G. When the recovered image has been correctly recovered, HF=G is theoretically derived, and the amount of evaluation assumes a value of 0. The smaller the amount of evaluation J, the better the recovery of the image F. Under the steepest descent method, repeated computation is iterated until the magnitude of ∇J serving as a gradient of the amount of evaluation J; namely, the square of a norm of ∇J, becomes equal to or smaller than a threshold value. At a point in time when the threshold value is attained, the repeated computation is terminated, to thus acquire a recovered image F. The amount of evaluation J is computed by use of the captured image (the deteriorated image G), the recovered image F, and the PSF, i.e., the deterioration function H, and ∇J is further computed. The square of the norm of the computed ∇J is compared with the threshold value, thereby determining whether or not the square is equal to or less than the threshold value. When the square is equal to or less than the threshold value, the norm of ∇J is deemed to have converged on an optimal solution in a sufficiently small manner, and repeated computation is terminated. Meanwhile, when the square of the norm of ∇J has exceeded the threshold value, recovery is determined to have not yet been performed sufficiently, and repeated computation is carried out. Here, the captured image designated to be subjected to camera shake correction by the user is a captured image having added date data. If the captured image is subjected directly to camera shake correction processing, camera shake in the image is corrected. However, since camera shake does not originally exist in the date data per se, blurring arises when the date data are subjected to recovery processing by use of the PSF conforming to the amount of camera shake detected by the gyroscopic sensor 24 (see FIG. 5).

Accordingly, when performing camera shake correction using a PSF, the image processing section 22 of the present embodiment causes the date data to disappear by use of the image data stored in the storage section 20; namely, the image data that are a part of the captured image before addition of date data and that pertain to the area where the date data are to be added. Specifically, the image data stored in the storage section 20 are merged into the captured image having added date data, thereby overwriting the date data. Accordingly, a captured image not having date data is created from the captured image having added date data, and the captured image not having date data are subjected to camera shake correction processing using a PSF. The control section 16 integrally controls operations of respective sections; especially, reading and writing of data from and to the storage section 20.

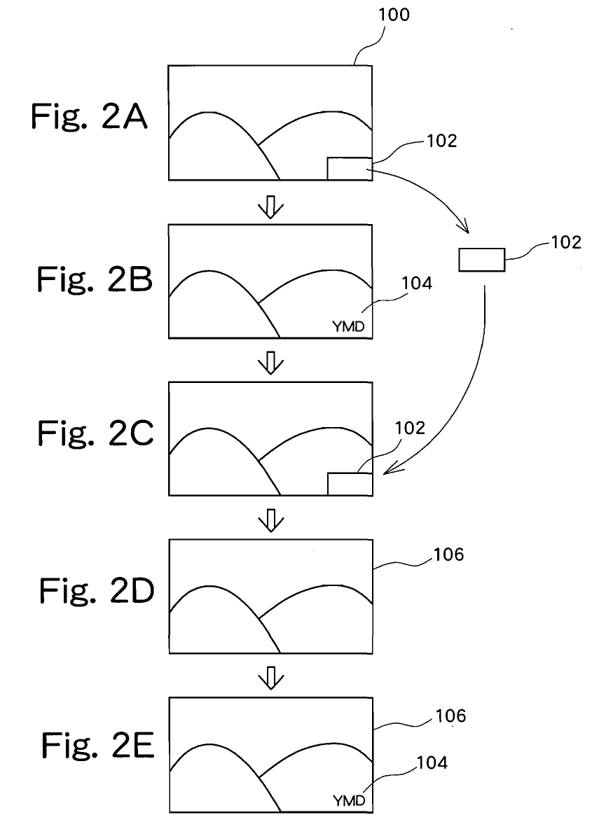

FIGS. 2A to 2E diagrammatically show camera shake correction processing performed by the image processing section 22. First, as shown in FIG. 2A, there are extracted image data 102 pertaining to an area in a captured image 100 of a file format, such as YCC 420 or the like, where date data are to be added, and the extracted image data are JPEG-compressed and stored in the storage section 20. Next, as shown in FIG. 2B, date data 104 are added to the captured image 100. The date data 104 are denoted as YMD in the drawing. The captured image 100 including the added date data 104 is JPEG-compressed and recorded in the external recording medium 26, and is displayed on the rear LCD, as well. When the user has designated the captured image 100 to be subjected to camera shake correction by visually ascertaining the captured image 100 appearing on the rear LCD, the image data 102 stored in the storage section 20 are read as shown in FIG. 2C. The read image data are decoded into a format, such as YCC 420 or the like, and the decoded image data are written over and merged into the area in the captured image 100 where the date data 104 are added. Since the date data 104 do not exist in the image data 102, the date data 104 disappear from the captured image 100 as a result of the image data 102 being merged into the captured image 100. After disappearance of the date data 104 in the manner mentioned above, camera shake correction processing using the PSF is performed, to thus recover the original image 106 as shown in FIG. 2D. Finally, as shown in FIG. 2E, the date data 104 are again added to the predetermined position in the original image 106, and the image is JPEG-compressed and recorded in the external recording medium 26.

In the present embodiment, what is to be stored in the storage section 20 is the image data 102 pertaining to the area in the captured image where the date data 104 are to be added rather than the captured image data 100 not having added date data 104, and hence the volume of data is small. Accordingly, the amount of memory required by the storage section 20 is small. Moreover, since the image data 102 used for causing the date data 104 to disappear are originally a part of the captured image data 100, an artificial contour, which arises when other image data are used, does not arise. The user is allowed to designate the captured image 100 including the added date data 104, and the original image 106 including the added date data 104 can be provided to the user.

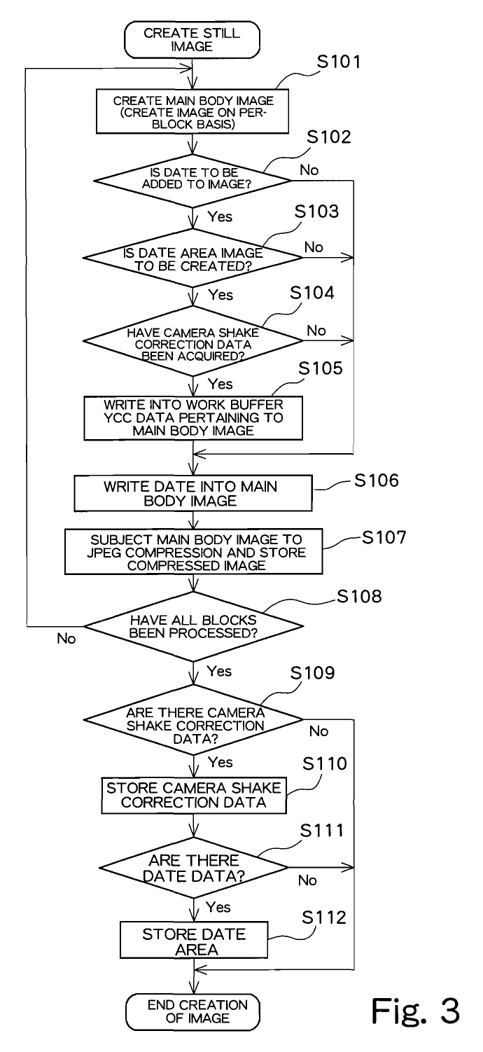

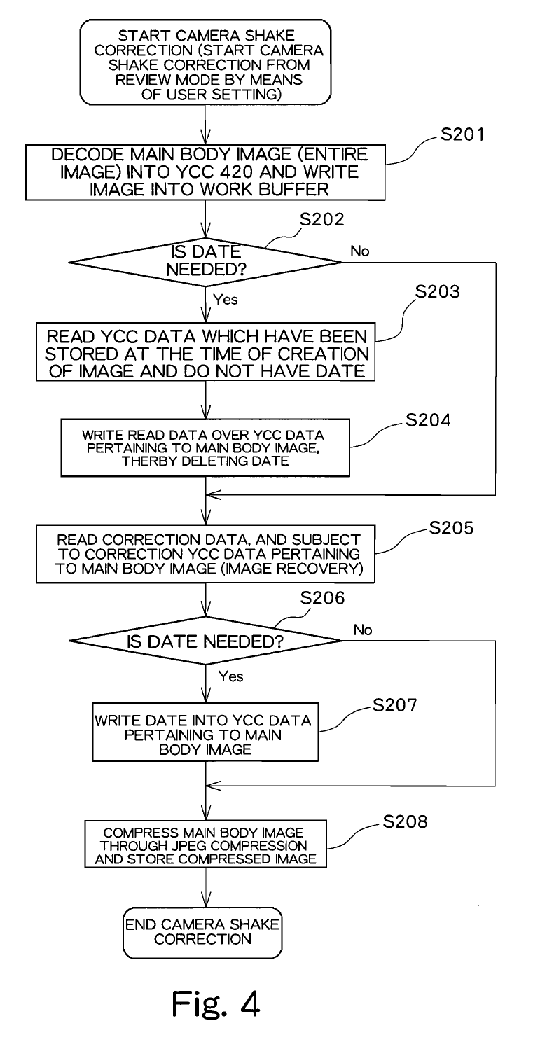

FIGS. 3 and 4 show detailed processing flowcharts of the present embodiment. FIG. 3 shows processing for creating a captured image (a still image). First, a main body image corresponding to the captured image 100 is created. When an image is created, processing for creating an image at one time cannot be performed. Therefore, an image is created in units of several blocks. For example, the image is divided into a block of 32×32 pixels, and processing is performed on a per-block basis. A certain block is sliced off from the main body image (S101), and a determination is made as to whether or not date data are to be added (S102). When the user has selected “Add a date” from a menu, the determination is YES. When date data are to be added, a determination is made as to whether or not the block of interest is a block to which date data are to be added (S103). Since coordinates of the area to which date data are to be added have already been determined for each image size, the determination is rendered in accordance with the coordinates. When the block corresponds to a block to which date data are to be added, another determination is made as to whether or not camera shake correction data corresponding to a PSF have been acquired (S104). The camera shake detection section 18 computes a PSF from a detection signal from the gyroscopic sensor 24, and a determination is made as to whether or not a PSF has been computed and stored in a work buffer. When the PSF has been computed, image data of YCC 420 format pertaining to the block of interest are written into a work buffer (S105). After the image data have been written into the work buffer, date data are added to the block (S106). The block is JPEG-compressed and stored in the storage section 20. Processing mentioned above is iteratively performed with regard to all of the blocks (S108).

After processing has been performed with regard to all of the blocks, a determination is made as to whether or not the PSF of camera shake correction data is present in the main body image consisting of all of the blocks (S109). If the PSF exists, the PSF data are written into the header of the main body image file (S110). Next, a determination is made as to whether or not the date data are present (S 111). When the date data are present, the image data written in the work buffer are stored in the storage section 20. Through processing mentioned above, the image data 102 to which date data are not added are stored in the storage section 20, and the captured image 100 having added date data is stored in the storage section 20. The captured image 100 stored in the storage section 20 is further recorded in the external recording medium 26. The storage section 20 is preferably nonvolatile memory. The reason for this is that there may also arise a case where the power of the digital camera is once deactivated after photographing operation and that the user desires camera shake correction of a captured image after having reactivated power.

FIG. 4 shows processing for performing camera shake correction. Camera shake correction is commenced when the user commands performance of camera shake correction by selecting a captured image which is an object of correction. First, the main body image corresponding to the captured image selected by the user is decoded into a YCC 420 format and written into the work buffer (S201). Next, a determination is made as to whether or not date data have already been added to the main body image (S202). When the date is added, the image data stored in the storage section 20 at the time of creation of the main body image are decoded into the YCC 420 format and written into the work buffer (S203). The image data are superimposed on the main body image, thereby deleting the date data pertaining to the main body image (S204). The position where the image data are to be overwritten is identical with the area where the date data are to be added, and coordinate data pertaining to the area where the date data are to be added can be used in unmodified form. After deletion of the date data, the PSF data written in the header of the main body image are extracted, and the original image is recovered from the main body image by use of the PSF data (S205).

After recovery of the original image, a determination is made as to whether or not a date is required (S206). When date data are deleted by overwriting the image data, date data may also be automatically deemed to be required without performance of determination processing. When the date is required, date data are again added to the original image; namely, the recovered main body image (S207), and the image is JPEG-compressed and stored in the storage section 20 (S208).

Although the present embodiment has been described by means of taking date data as an example, the present invention can be applied to arbitrary character data other than a date. The character data include any of characters, numerals, symbols, and marks.

Further, in the present embodiment, the image data pertaining to the area in the captured image where date data are to be added are JPEG-compressed and stored in the storage section 20. However, the image data may also be stored, while remaining in the YCC format, in the storage section 20.

In the present embodiment, the image data pertaining to the area where the date data are to be added are extracted and stored. However, so long as the volume of memory of the storage section 20 permits, image data pertaining to a predetermined area including the area where date data are to be added may also be extracted and stored. In short, the essential requirement is to cause the date data added to the captured image to disappear; or to extract image data pertaining to an area sufficient to be deleted. The area to be extracted is determined according to the size of the character data added to a captured image. The area to be extracted can be defined as having at least a size equal to or greater than the size of the character data.

In the present embodiment, image data pertaining to an area to which date data are to be added are extracted from all of captured images to which a date is added, and the extracted image data are stored in the storage section 20. However, in relation to a captured image which cannot be subjected to camera shake correction because the amount of camera shake exceeds an allowable value, or the like, it may be the case that image data pertaining to an area where date data are to be added are not extracted. Since camera shake correction is not performed, there is no necessity to extract, from a captured image, image data pertaining to an area to which date data are to be added. Consequently, extracting image data from only a captured image to which a date is added and which can be subjected to camera shake correction is preferable. In the present embodiment, image data are written into a work buffer, through processing pertaining to S104 and S105 in FIG. 3, on the premise that PSF data serve as camera shake correction data. However, for instance, in a case where sufficient accuracy is not ensured for reasons of an excess amount of camera shake even when a PSF can be computed, it may be the case that data are not written into a work buffer. Specifically, the accuracy of camera shake correction data acquired after processing pertaining to S104 is determined through processing shown in FIG. 3. Only when there is accuracy of an order of magnitude which allows camera shake correction, image data may be written into the work buffer. According to whether or not an angular velocity detected by the gyroscopic sensor 24 falls within an allowable range, a determination may also be rendered as to whether or not camera shake correction is feasible.

### PARTS LIST

10 CCD
12 analog front end
14 image processing
16 control block
18 shake detection section
20 storage section
22 image processing section
24 gyroscopic sensor
26 recording medium
100 captured image
102 extracted image data
104 data
106 original image

What is claimed is:

1. An image recovery device for recovering an original image from an acquired image, comprising;
a unit for creating a character-added image by addition of character data to an acquired image;
a unit for previously storing image data pertaining to an area in the acquired image where the character data are to be added before addition of the character data to the acquired image;
a unit for merging the image data into a character data addition area in the character-added image at the time of recovery of an original image from the character-added image, thereby causing the character data to disappear and recover the original image; and
a unit for again adding the character data to the recovered original image.

2. The image recovery device according to claim 1, wherein the character data correspond to date data.

3. The image recovery device according to claim 1, wherein the acquired image corresponds to a captured image, and recovery corresponds to camera shake correction.

4. The image recovery device according to claim 3, further comprising:
a unit for determining whether or not the captured image can be subjected to camera shake correction, wherein the unit for storage previously stores image data pertaining to an area where the character data are to be added when camera shake correction is possible.
